(19) United States
(12) Patent Application Publication
(10) Pub. No.: US 2013/0124044 A1
(43) Pub. Date: May 16, 2013

(54) ELECTRICAL LIMITATION OF A STEERING DEVICE PATH

(71) Applicant: GM GLOBAL TECHNOLOGY OPERATIONS LLC, Detroit, MI (US)

(72) Inventor: Thomas DEGENSTEIN, Mainz (DE)

(73) Assignee: GM GLOBAL TECHNOLOGY OPERATIONS LLC, Detroit, MI (US)

(21) Appl. No.: 13/668,122

(22) Filed: Nov. 2, 2012

(30) Foreign Application Priority Data
Nov. 2, 2011 (DE) 10 2011 117 500.1

(51) Int. Cl. B62D 15/02

(52) U.S. Cl. CPC B62D 15/02
USPC 701/41

(57) ABSTRACT

An electrical limitation of a travel of a steering device of a wheeled vehicle, in particular of a passenger car, including a control, is provided. The method includes reading-in of a stored vehicle configuration into the control of the steering device, and deriving an adjusting value limitation from the read-in vehicle configuration. The method includes electrically limiting travel of the steering device through the control based on the derived adjusting value limitation.

### CROSS-REFERENCE TO RELATED APPLICATION

This application claims priority to German Patent Application No. 10 2011 117 500.1, filed Nov. 2, 2011, which is incorporated herein by reference in its entirety.

### TECHNICAL FIELD

The present disclosure relates to a method for the electrical limitation of a path of a steering device of a wheeled vehicle, in particular a passenger car, and to a steering device that is equipped for carrying out such a method.

### BACKGROUND

The free space of a wheel in a wheel housing limits a possible steer angle. In particular, in order to avoid that the steered wheel contacts the wheel housing the steer angle is therefore limited.

From DE 10 2008 055 900 A1 a steering device for a motor vehicle is known, wherein a maximum steer angle is electronically adjustable. Based on detected external peripheral conditions, the maximum steer angle can be automatically adapted. To this end, via an electronic stability program (ESP), a control/regulating device determines based on a slip behavior if snow chains are being used. A wheel/tire size can be manually entered via an on-board computer, automatically detected by means of an RFID-tag or calculated in interaction with a navigation system, tachometer and speedometer.

Such an indirect determination of the wheel size, if applicable including snow chains, is complicated and not precise. The direct manual entry via on-board computer is likewise complicated and additionally error-prone.

Accordingly, it may be desirable to improve the electrical limitation of a travel of a steering device of a wheeled vehicle. In addition, other objects, desirable features and characteristics will become apparent from the subsequent summary and detailed description, and the appended claims, taken in conjunction with the accompanying drawings and this background.

### SUMMARY

According to various aspects of the present disclosure, a stored vehicle configuration is read in to a steering device of a wheeled vehicle, in one example of a passenger car or commercial vehicle. The vehicle configuration can in one example comprise identifiers such as chassis number, specifications such as current tires and/or approved tires, a steering characteristic curve which imparts a relationship between an actuation of a steering means and an adjusting travel of the steering device, a widening of wheel housings, a chassis that has been lowered and/or widened relative to a standard, a country of delivery for the vehicle and the like.

From the read-in vehicle configuration, an adjusting value limitation is automatically derived. An adjusting value limitation is to mean in one example, a limit value for an adjusting movement of the steering device, the exceeding of which is strictly made more difficult, in one example, prevented.

To this end, an adjusting value limitation can be directly specified in the vehicle configuration, in one example, as a separate file, for example in millimeters (mm) or degrees (°). Equally, it can also be determined from the values of the vehicle configuration, in one example from a mounted and/or permissible wheel dimension, a vehicle type, special equipment or the like.

For example, a starting adjusting travel limitation can be specified for a vehicle type. This can be changed corresponding to the further vehicle configuration, for example made smaller when wider tires are approved, enlarged when the wheel housings have been widened or the like. In an exemplary embodiment, a wheel dimension, in one example, a tire width and/or tire height of mounted and/or approved wheels can be directly specified in the vehicle configuration or be derived from the latter, for example, in table form, and from the wheel dimension in turn an adjusting value limitation, in one example, in table form, derived.

Accordingly, in one exemplary embodiment, a stored vehicle configuration comprises at least one wheel dimension, in one example a generally standardized tire width and/or height, and in a further exemplary embodiment, a stored wheel dimension along can also form a stored vehicle configuration in terms of the present disclosure. Additionally or alternatively, a stored vehicle configuration can comprise or be a vehicle type, a chassis number, special equipment, a body and/or chassis classification.

Following this, an adjusting travel of the steering device is electrically limited through the control based on this adjusting value limitation derived from the vehicle configuration.

By deriving the adjusting value limitation from the vehicle configuration that is available, a complicated manual input in direct measurement can be advantageously avoided. In addition, the risk of errors being manually entered or errors with indirect measurements is reduced.

In one exemplary embodiment, adjusting travel limitations can be differently specified for a first and a second adjusting direction, for example for a steer angle to the left and to the right. Because of this, vehicle-specific asymmetries can be taken into account.

In one exemplary embodiment it is provided that the further stored vehicle configuration can be optionally read in, and from this a further adjusting value limitation can be derived and an adjusting travel of the steering device can be electrically limited through the control based on the further set value limitation. In this manner, an adjusting value limitation for example during a retrofitting or conversion of the vehicle can be adapted easily, precisely and in an error-proof manner.

A stored vehicle configuration can be read in to the control through reading-out of a storage medium, in a wire-based or wireless manner, in one example, by way of radio or IR-technology. In this manner, the reading-in and deriving of the adjusting value limitation in the case of a change of the vehicle configuration can be carried out very easily and in an error-proof manner.

The steering device in one exemplary embodiment comprises a steering drive and/or a steering means, in one example, a steering wheel, a control stick or the like in order to steer one or a plurality of wheels of the vehicle, for example, in order to at least rotate an axle. The steering drive in one exemplary embodiment comprises one or a plurality of electrical actuators, in one example, one or a plurality of electric motors and/or electromagnets, which are actuated based on a sensed steering means actuation, for example, of an adjustment of the steering means caused by the drive and/or a force exerted on the steering means by the driver. The steering angle drive can also comprise one or a plurality of hydraulic actuators, which are electrically controlled, for example via electrical control valves or the like. Such actuators, too, are referred to as electrical actuators here.

The steering means can be mechanically and/or hydraulically coupled to the wheel or wheels, in one example, via a steering rod, a rack, track rods and the like. One or a plurality of electrical actuators of the steering drive can be provided to support a steering actuation of the steering means by a driver, in that forces exerted by these are superimposed on the forces exerted by the driver (“electric power steering”, EPS). In one example, a servo motor can impose an additional torque on a steering rod or a steering gear or a force in movement direction of a rack. Equally, the steering means can also be decoupled by the wheel or wheels (“drive-by-wire”), in that the wheel or wheels are only moved by the actuator or actuators and forces which the driver exerts on the steering means are not mechanically transmitted to the wheel or wheels.

The travel of the steering device can be electrically limited by the steering drive. In one example, the steering drive can exert a force on the steering device, for example, the steering means, which counteracts an exceeding of a specified limit value. The force can generally greatly increase in the vicinity of the limit value in order to electrically simulate a stop. Here, the force increase can for example depend proportionally, exponentially or in another relationship on a differential between adjusting travel and limit value. In the case of a drive-by-wire steering device, a retroactive actuator can additionally or alternatively impose a counterforce on the steering means and/or the adjusting travel of an adjusting actuator, which steers the wheel or wheels can be limited.

Equally, the adjusting travel of the steering device can also be electrically limited in that one or a plurality of in one example, mechanical stops are electrically, for example, electromotorically and/or electromagnetically or hydraulically adjusted.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 a steering device according to an exemplary embodiment of the present disclosure; and

FIG. 2 a method for the electrical limitation of an adjusting travel of the steering device of FIG. 1 according to an exemplary embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

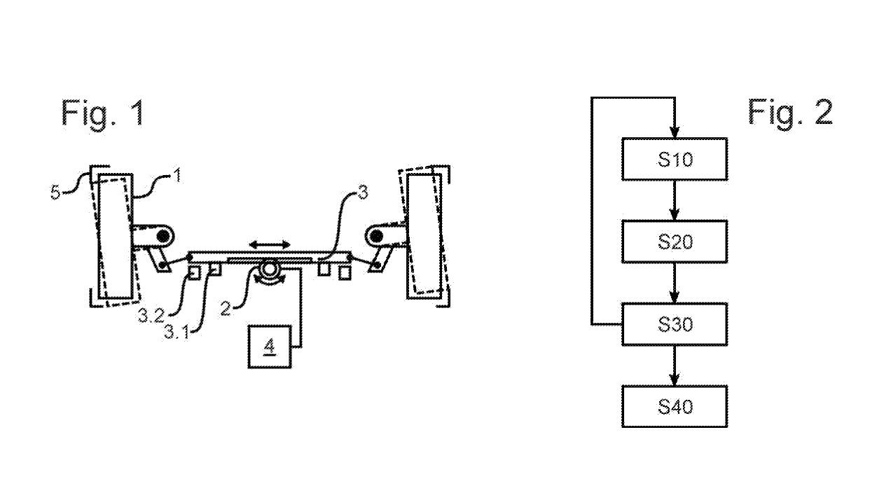

FIG. 1 shows exemplarily a steering device of a passenger car according to an exemplary embodiment of the present disclosure having two wheels 1 steered by means of a rack 3, which are received in wheel housings 5. For shifting the rack 3, an electric motor 2 of a steering drive acts on said rack, which supports a steering movement of a steering rod (not shown) which is operationally connected to a steering wheel or alone moves the rack decoupled from the steering wheel based on a sensed steering actuation of the steering wheel.

In addition to the steering drive in the form of the electric motor 2, the steering device in one example, comprises a control 4 that is signal-connected to said electric motor. Said control actuates the electric motor 2 and receives in one example, information regarding a current adjusting travel, for example a position of the rack 3 or an angle or rotation of the motor 2, and a force or electrical quantity applied thereon, for example an imposed torque, a power consumption or the like from said electric motor.

For the electrical limitation of the adjusting travel of this steering device, a vehicle configuration is initially at the end of an assembly of the passenger car in a step S10 read in to the control 2 of the steering device. This contains among other things the current tire dimensions as well as the tire dimensions approved for this vehicle, in one example, standardized tire heights and/or widths.

From this, the control 4 in a step S20 derives an adjusting value limitation for limiting the adjusting travel of the steering device. To this end, it selects from the current and from the additionally approved tire dimensions those combinations of tire height and tire width which together with a free space in the wheel housing known from the vehicle configuration defines the smallest maximum adjusting travel, i.e. that which is always possible for all approved wheel dimensions. This adjusting travel can be obtained for example with a widened wheel housing, a lowered chassis or the like known from the vehicle configuration. In one example, different wheel dimensions and additional values of the vehicle configuration such as a widening of the wheel housing or the like can each be assigned specified adjusting value limitations in table form, for example, as matrix, from which the control 4 selects the one that fits the read-in vehicle configuration.

When the vehicle configuration of the vehicle is changed, for example a track widening, lowering or the like have been carried out, the steps S10, S20 are automatically repeated as indicated in FIG. 2 by step S30.

Following this, the travel of the steering device is electrically limited in a step S40 based on the derived adjusting value limitation.

To this end, as explained above, the electric motor 2 on reaching the adjusting value limitation in form of a limit value, which can be different for an adjusting movement to the left and an adjusting movement to the right, can impose a counterforce which counteracts a continued steering by the driver, in one example, prevents such. In addition, with a drive-by-wire steering device, the travel of the electric motor 2 can be suitably limited. In one exemplary embodiment, the counterforce which the electric motor 2 as support actuator or with a drive-by-wire steering device imposes on a retroactive actuator, which actuates the steering wheel (not shown), can be amplified for example proportionally or exponentially on approaching the respective limit value and increasingly make it more difficult for the driver to continue to turn-in in the vicinity of the electrical stop.

In addition or alternatively to such a counterforce, which electrically simulates a stop, and by means of which the steering drive electrically limits the adjusting travel of the steering device, a limitation can be provided for example on the rack 3 and the passenger car through interacting stops 3.1, 3.2. Through electromotoric or electromagnetic adjustment of the stops 3.2 fixed to the passenger car the travel can be likewise electrically adjusted.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A method for the electrical limitation of a travel of a steering device of a wheeled vehicle having a control, comprising:
reading-in a stored vehicle configuration into the control of the steering device;
deriving an adjusting value limitation from the read-in vehicle configuration; and
electrically limiting travel of the steering device by the control based on the derived adjusting value limitation.

2. The method according to claim 1, wherein the adjusting value limitation is differently specified for a first and a second adjusting direction.

3. The method according to claim 1, wherein a further stored vehicle configuration can be read in, and from this a further adjusting value limitation can be derived and travel of the steering device can be electrically limited through the control on the basis of the further adjusting value limitation.

4. The method according to claim 1, wherein a stored vehicle configuration comprises at least one of a wheel dimension, a vehicle type, a chassis number, special equipment, a body, a chassis classification and combinations thereof.

5. The method according to claim 4, wherein the wheel dimension further comprises at least one of a standardized tire width and a tire height.

6. The method according to claim 1, wherein the travel of the steering device is electrically limited by at least one of a steering drive and an electrically adjustable stop.

7. A steering device for a wheeled vehicle, comprising:
a rack coupled to two wheels;
a steering drive coupled to the rack that moves the rack to steer the wheels;
a control that:
reads-in a stored vehicle configuration into the control of the steering device;
derives an adjusting value limitation from the read-in vehicle configuration; and
electrically limits travel of the steering device based on the derived adjusting value limitation.

8. A method for the electrical limitation of a travel of a steering device of a wheeled vehicle having a control, comprising:
reading-in a stored vehicle configuration into the control of the steering device;
deriving an adjusting value limitation from the read-in vehicle configuration; and
electrically limiting travel of the steering device by the control based on the derived adjusting value limitation with at least one of a steering drive and an electrically adjustable stop.

9. The method according to claim 8, wherein the adjusting value limitation is differently specified for a first and a second adjusting direction.

10. The method according to claim 8, wherein a further stored vehicle configuration can be read in, and from this a further adjusting value limitation can be derived and travel of the steering device can be electrically limited through the control on the basis of the further adjusting value limitation.

11. The method according to claim 8, wherein a stored vehicle configuration comprises at least one of a wheel dimension, a vehicle type, a chassis number, special equipment, a body, a chassis classification and combinations thereof.

12. The method according to claim 11, wherein the wheel dimension further comprises at least one of a standardized tire width and a tire height.
